(19) United States
(12) Patent Application Publication
(10) Pub. No.: US 2023/0279567 A1
(43) Pub. Date: Sep. 7, 2023

(54) BRINE ELECTROLYZER

(71) Applicant: Washington University, St. Louis, MO (US)

(72) Inventors: Shrihari Sankarasubramanian, St. Louis, MO (US); Pralay Gayen, St. Louis, MO (US); Vijay Ramani, St. Louis, MO (US)

(21) Appl. No.: 18/005,867

(22) PCT Filed: Jul. 21, 2021
(86) PCT No.: PCT/US2021/042536

§ 371 Date: Jan. 18, 2023

Related U.S. Application Data
(60) Provisional application No. 63/054,356, filed on Jul. 21, 2020.

(51) Int. Cl. C25B 11/077; C25B 1/04; C25B 9/23

(52) U.S. Cl. CPC C25B 11/077; C25B 1/04; C25B 9/23

(57) ABSTRACT

Described herein is a brine electrolyzer including a pyrochlore electrocatalyst. The brine may include natural or added perchlorate salts. Also described herein are methods of using the brine electrolyzer. Advantages of this brine electrolyzer include device operation at near-neutral pH, device operation without the need for a deionized water feed, and the use of selective catalysts at the anode that favor oxygen evolution and mitigate the occurrence of unwanted side reactions.

### CROSS-REFERENCE TO RELATED APPLICATIONS

This application claims priority to U.S. Provisional Application Serial No. 63/054356, filed on Jul. 21, 2020, the content of which is hereby incorporated by reference in its entirety.

### FIELD OF THE DISCLOSURE

Described herein is a brine electrolyzer including a pyrochlore electrocatalyst. The brine may include natural or added perchlorate salts. Also described herein are methods of using the brine electrolyzer. Advantages of this brine electrolyzer include device operation at near-neutral pH, device operation without the need for a deionized water feed, and the use of selective catalysts at the anode that favor oxygen evolution and mitigate the occurrence of unwanted side reactions.

### BACKGROUND OF THE DISCLOSURE

Water electrolysis using renewable energy sources has been recognized as one of the most promising techniques for hydrogen and oxygen production with minimal environmental consequences. Water electrolysis is primarily done through a proton-exchange-membrane (PEM) or alkaline electrolyzer. However, these systems require high purity water feeds and such feeds substantially increase operational costs.

High-performance alkaline water electrolyzers using Pb₂Ru₂O_{7-δ} as oxygen evolution reaction (OER) electrocatalysts are known. The activity of such electrocatalysts for both O₂ reduction as well as evolution reactions is well established. A shift from low pH operation to high pH, by alkaline operation, is advantageous because it enables the replacement of expensive platinum or iridium based catalysts with economical alternatives. In the present disclosure, the use of Pb₂Ru₂O_{7-δ} and other pyrochlore catalysts allows a significant reduction in the amount of platinum group metal (PGM) used in a given electrolyzer cell.

One possible way to reduce costs is to replace high purity water with briny or brackish water in the electrolyzer. Using briny or brackish water also increases availability of water sources and allows application of water electrolyzers with unconventional water sources, such as seawater or extraterrestrial liquid water. Use of seawater would provide an abundant resource for terrestrial energy production. Use of extraterrestrial liquid water would provide an on-site resource to produce life support O₂ and fuel H₂. The use of brine will also enable use of wastewater from a variety of industrial sources and power plants as the feed source for this electrolyzer. The dissolved salts in the electrolyzer reduce the overall cell voltage, thereby improving its energy efficiency.

The electrolyzers using briny or brackish water could be particularly useful in space exploration. It is well known that life support O₂ and fuel such as H₂ are indispensable for human space exploration. The electrolysis of extraterrestrial liquid water can be a significant concurrent source of H₂ and O₂.

The United States National Aeronautics and Space Administration’s (NASA) Phoenix lander has found evidence of an active water cycle, extensive sub-surface ice, and the presence of soluble perchlorates on the Martian surface. Spectral evidence from the Mars Odyssey Gamma Ray Spectrometer (GRS) points to the existence of large quantities of water-ice in the northern polar region of Mars and the Mars Reconnaissance Orbiter (MRO) has also found indications of contemporary local flows of liquid regolithic brines shaping Martian geography.

Martian regolithic brines with dissolved perchlorates exist in the liquid phase since perchlorates significantly depress the freezing point of water. Based on compositional analysis by the wet chemistry instrument (WCI) on the Phoenix lander, Mg(ClO₄)₂ is reported to be a major constituent of the Martian regolith and its concentrated solutions remain in the liquid phase up to about -70° C. This offers a temperature window for the existence of liquid brine on the Martian surface and subsurface as the mean annual terrestrial temperature on Mars is about -63° C. with a wide (>100° C.) average diurnal variation. The hygroscopic nature of these perchlorates also enables the entrainment of atmospheric water vapor to produce concentrated brine solutions.

The Martian atmosphere significantly differs from that of Earth’s, with its predominant constituent being CO₂. CO₂ reduction has been shown to be unlikely in similar perchlorate electrolytes. Although the atmospheric pressure on Mars (6.4 mbar) is significantly lower than that of Earth (1013 mbar), highly concentrated Mg(ClO₄)₂ solutions remain in the liquid phase under Martian temperature and pressure conditions.

Regolithic brine electrolysis under Martian conditions is demonstrated herein. Such an electrolysis will enable the production of ultra-pure O₂ for life-support and H₂ for energy production, with no additional purification requirement for CO removal. The H₂ produced in tandem can serve as a clean burning fuel with a superior calorific value to CO. This electrolyzer system has a 25-fold higher production rate of O₂, when compared to NASA’s Mars Oxygen In-Situ Resource Utilization Experiment (MOXIE), while consuming the same amount of power. As such, this system consumes 25 times less power than MOXIE for the same O₂ production rate.

Described herein is a brine electrolyzer that electrochemically splits brine to produce hydrogen at the cathode and oxygen at the anode. Advantages of the present brine electrolyzer include device operation at near-neutral pH (thereby avoiding the material challenges encountered when operating in acidic or alkaline conditions), device operation without the need for a deionized water feed (by either using briny/brackish water feeds or by the deliberate addition of perchlorate salts to the input feed to enhance performance), and the use of selective catalysts at the anode that favor oxygen evolution and mitigate the occurrence of unwanted side reactions including, but not limited to, chlorine evolution.

### BRIEF DESCRIPTION OF THE DISCLOSURE

In one embodiment, the present disclosure is directed to an electrolytic cell comprising a cathode, an anode comprising a pyrochlore, an ion exchange membrane separating the cathode and the anode, and a brine solution in contact with the anode and the cathode, wherein the brine solution optionally comprises a perchlorate salt.

In another embodiment, the present disclosure is directed to a method of using an electrolytic cell. The method comprises using the electrolytic cell to produce H₂ and O₂ from a brine solution, wherein the electrolytic cell comprises a cathode, an anode comprising a pyrochlore, an ion exchange membrane separating the cathode and the anode, and a brine solution in contact with the anode and the cathode, wherein the brine solution optionally comprises a perchlorate salt.

### BRIEF DESCRIPTION OF THE DRAWINGS

FIG. 1A is an exemplary embodiment of an LSV of Pb₂Ru₂O_{7-δ} pyrochlore, RuO₂, and GC at 21° C. in accordance with the present disclosure.

FIG. 1B is an exemplary embodiment of an LSV of Pb₂Ru₂O_{7-δ} pyrochlore, RuO₂, and GC at -36° C. in accordance with the present disclosure.

FIG. 1C is an exemplary embodiment of an LSV of Pb₂Ru₂O_{7-δ} pyrochlore, RuO₂, and GC in accordance with the present disclosure.

FIG. 2A is an exemplary embodiment of a schematic of a brine electrolyzer in accordance with the present disclosure.

FIG. 2B is an exemplary embodiment of electrolyzer polarization (E vs. j) and tandem H₂ (red circle)/O₂ (blue triangle) production rate under a simulated Martian environment in accordance with the present disclosure.

FIG. 3A is an exemplary embodiment of efficiency of an electrolyzer in accordance with the present disclosure at 21° C. and -36° C.

FIG. 3B is an exemplary embodiment of stability of an electrolyzer in accordance with the present disclosure at 21° C. and -36° C.

FIG. 4 is an exemplary embodiment of O₂ production as a function of power consumption electrolyzer volume and electrolyzer weight vs. power consumption for different consumption rates for an electrolyzer in accordance with the present disclosure.

FIG. 5A is an exemplary embodiment of XPS spectra of O 1s of Pb₂Ru₂O_{7-δ} in accordance with the present disclosure.

FIG. 5B is an exemplary embodiment of XPS spectra of Ru 3p of Pb₂Ru₂O_{7-δ} in accordance with the present disclosure.

FIG. 5C is an exemplary embodiment of XPS spectra of Pb 4f of Pb₂Ru₂O_{7-δ} in accordance with the present disclosure.

FIG. 6A is an exemplary embodiment of an OER LSV of Pb₂Ru₂O_{7-δ} under O₂ purged SMRB and over a range of temperatures (21° C. to -36° C.) in accordance with the present disclosure.

FIG. 6B is an exemplary embodiment of an OER LSV of RuO₂ under O₂ purged SMRB and over a range of temperatures (21° C. to -36° C.) in accordance with the present disclosure.

FIG. 6C is an exemplary embodiment of an OER LSV of glassy carbon (GC) under O₂ purged SMRB and over a range of temperatures (21° C. to -36° C.) in accordance with the present disclosure.

FIG. 7A is an exemplary embodiment of an OER LSV of Pb₂Ru₂O_{7-δ} pyrochlore under CO₂ purged SMRB and over a range of temperatures (21° C. to -36° C.) in accordance with the present disclosure.

FIG. 7B is an exemplary embodiment of an OER LSV of Pb₂Ru₂O_{7-δ} pyrochlore under O₂ purged SMRB and over a range of temperatures (21° C. to -36° C.) in accordance with the present disclosure.

FIG. 8A is an exemplary embodiment of Tafel slopes of Pb₂Ru₂O_{7-δ}, RuO₂ and GC under O₂- and CO₂-purged SMRB at 21° C. in accordance with the present disclosure.

FIG. 8B is an exemplary embodiment of Tafel slopes of Pb₂Ru₂O_{7-δ}, RuO₂ and GC under O₂- and CO₂-purged SMRB at -36° C. in accordance with the present disclosure.

FIG. 8C is an exemplary embodiment of Tafel slopes of Pb₂Ru₂O_{7-δ} under CO₂-purged SMRB at different temperatures in accordance with the present disclosure.

FIG. 8D is an exemplary embodiment of Tafel slopes of Pb₂Ru₂O_{7-δ} under O₂- SMRB at different temperatures in accordance with the present disclosure.

FIG. 9 is a proposed, non-limiting reaction scheme for the ORR in acidic and near-neutral environments in accordance with the present disclosure.

FIG. 10 is an exemplary embodiment of ORR current density at 200mV overpotential vs. onset potential for Pb₂Ru₂O_{7-δ} and GC at O₂-purged SMRB at different temperatures in accordance with the present disclosure.

FIG. 11 is an exemplary embodiment of Tafel slopes for HER with Pt/C in CO₂-purged SMRB at different temperatures in accordance with the present disclosure.

FIG. 12 is an exemplary embodiment of the resistance and conductivity of the electrolytic solution at different temperatures in accordance with the present disclosure.

FIG. 13 is an exemplary embodiment of an SMRB electrolyzer polarization curve (diamonds), O₂ production (triangles) and H₂ production (circles) at 21° C. in accordance with the present disclosure.

FIG. 14 is an exemplary embodiment of an XRD spectrum of a prepared Pb₂Ru₂O_{7-δ} pyrochlore sample in accordance with the present disclosure.

FIG. 15 is an exemplary embodiment of an SEM image of a prepared Pb₂Ru₂O_{7-δ} sample in accordance with the present disclosure.

FIG. 16A is an exemplary embodiment of a layered EDAX image of a prepared pyrochlore sample in accordance with the present disclosure.

FIG. 16B is an exemplary embodiment of elemental mapping of O on a layered EDAX image of a prepared pyrochlore sample in accordance with the present disclosure.

FIG. 16C is an exemplary embodiment of elemental mapping of Ru on a layered EDAX image of a prepared pyrochlore sample in accordance with the present disclosure.

FIG. 16D is an exemplary embodiment of elemental mapping of Pb on a layered EDAX image of a prepared pyrochlore sample in accordance with the present disclosure.

### DETAILED DESCRIPTION OF THE DISCLOSURE

Described herein is an electrolytic cell comprising a cathode, an anode comprising a pyrochlore, an ion exchange membrane separating the cathode and the anode, and a brine solution in contact with the anode and the cathode. The brine solution optionally comprises a perchlorate salt.

As used herein, a pyrochlore is a compound having the pyrochlore crystal structure (Fd3m).

In some embodiments, the pyrochlore comprises oxygen and at least two different rare earth or transition metal species.

In some embodiments, the pyrochlore is a compound according to Formula I:

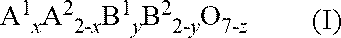

wherein A¹ and A² are each independently selected from the group consisting of Pb, Y, La, Gd, Bi, Dy, Cd, Tl, and Ca; B¹ and B² are each independently selected from the group consisting of Ru, Ir, Rh, Re, Sn, Ti, Pt, Os, Zr, and Pd; x is a value between 0 and 2; y is a value between 0 and 2; and z is a value between 0 and 1.

In some embodiments, x is selected from the group consisting of 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, and 2.0.

In some embodiments, y is selected from the group consisting of 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, and 2.0.

In some embodiments, z is selected from the group consisting of 0, 0.1, 0.2, 0.3, 0.4, 0.5, 0.6, 0.7, 0.8, 0.9, and 1.0.

In some embodiments, the pyrochlore is a compound according to Formula II:

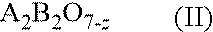

wherein A is selected from the group consisting of Pb, Y, La, Gd, Bi, Dy, Cd, and Tl; B is selected from the group consisting of Ru, Ir, Rh, Sn, Ti, Pt, Os, and Pd; and z is a value between 0 and 1.

In some embodiments, A is Pb.

In some embodiments, B is Ru.

In some embodiments, z is selected from the group consisting of 0, 0.1, 0.2, 0.3, 0.4, 0.5, 0.6, 0.7, 0.8, 0.9, and 1.0.

In some embodiments, the pyrochlore is Pb₂Ru₂O_{7-z}.

In some embodiments, the pyrochlore does not comprise Bi. In some embodiments, the pyrochlore is essentially free of Bi. In some embodiments, the pyrochlore being essentially free of Bi means that the pyrochlore comprises less than about 5% of Bi.

In some embodiments, the cathode comprises a catalyst selected from the group consisting of Pt, Pd, alloys of Pt and alloys of Pd supported on C, RuO₂, Ni(OH)₂, TiO₂, SnO₂, TiO₂ with Nb or Ru dopants, SnO₂ with Sb or Ta dopants, and combinations thereof. Suitable alloys of Pd supported on C are described in US9799881, which is incorporated by reference herein.

In some embodiments, the cathode comprises a Pt/C catalyst. In some embodiments, the cathode comprises a Pt/RuO₂-TiO₂ catalyst. In some embodiments, the cathode comprises a Pt/C/ Ni(OH)₂ catalyst.

As used herein, brine is a solution comprising water and relatively high concentrations of NaCl. In some embodiments, brine is a solution comprising water, relatively high concentrations of NaCl, and perchlorate salts. In some embodiments, brine is a solution comprising a salt comprising (i) at least one cation selected from the group consisting of lithium, sodium, potassium, barium, calcium, magnesium and ammonium; and (ii) at least one anion selected from the group consisting of chloride, perchlorate, sulfate, carbonate, bicarbonate and nitrate.

In some embodiments, the brine is brackish water. In some embodiments, the brine has a NaCl concentration in the range of from about 0.05% to about 3%, from about 0.10% to about 2%, or from about 0.15% to about 1%.

In some embodiments, the brine is saline water. In some embodiments, the brine has a NaCl concentration in the range of from about 3% to about 5%.

In some embodiments, the brine is seawater. In some embodiments, the brine has a NaCl concentration of about 3.5%.

In some embodiments, the brine is a saturated brine. In some embodiments, the brine has a NaCl concentration in the range of from about 5% to about 28%, from about 10% to about 25%, or from about 15% to about 20%. In some embodiments, the brine has a NaCl concentration greater than about 28%.

In some embodiments, the brine solution comprises a perchlorate salt. The perchlorate salt improves the electrolyte conductivity without blocking the catalytic reaction sites, thereby improving cell performance.

In some embodiments, the brine solution comprises a perchlorate salt in a concentration in the range of from about 0.1 M to about 3 M, from about 0.5 M to about 2 M, or from about 0.75 M to about 1.5 M.

In some embodiments, the electrolytic cell comprises a perchlorate salt selected from the group consisting of Mg(ClO₄)₂, Ca(ClO₄)₂, NaClOs, salts of Li, Ba, K, and Mg, and combinations thereof.

In some embodiments, the brine solution comprises CO₂. In some embodiments, the CO₂ is added to the brine solution. In some embodiments, the brine solution comprises CO₂ that is added to a natural brine solution. In some embodiments, the brine solution naturally comprises CO₂. Brine solutions that naturally include CO₂ may include CO₂ dissolved from the atmosphere. In some embodiments, the brine solution comprises CO₂ at a concentration in the range of from about 0.0001 M to about 3 M.

In some embodiments, the brine solution has a neutral pH or a near neutral pH. In some embodiments, the brine solution has a pH in the range of from about 7 to about 8.

In some embodiments, the ion exchange membrane is selected from the group consisting of an anion exchange membrane and a proton exchange membrane. In some embodiments, the ion exchange membrane is an anion exchange membrane. In some embodiments, the ion exchange membrane is selected from the group consisting of block copolymers, SEBS membranes, QPEK membranes, and combinations thereof.

In some embodiments, any suitable anion exchange membrane known in the art is used. Suitable anion exchange membranes include those described in US20190044158 and WO2020028374, which are incorporated by reference herein.

Also described herein is a method of using an electrolytic cell, wherein the electrolytic cell comprises a cathode, an anode comprising a pyrochlore, an ion exchange membrane separating the cathode and the anode, and a brine solution in contact with the anode and the cathode. The brine solution optionally comprises a perchlorate salt. The method comprises using the electrolytic cell to produce H₂ and O₂ from the brine solution.

In some embodiments, the method step of using the electrolytic cell to produce H₂ and O₂ from the brine solution comprises applying a current having a current density in the range of from about 500 mA/cm² to about 1500 mA/cm². In some embodiments, the method step of using the electrolytic cell to produce H₂ and O₂ from the brine solution comprises applying a current having a current density less than about 1000 mA/cm². In some embodiments, the method step of using the electrolytic cell to produce H₂ and O₂ from the brine solution comprises applying a current having a current density greater than about 1000 mA/cm² at below 2 V cell voltage.

In some embodiments, the method step of using the electrolytic cell to produce H₂ and O₂ from the brine solution comprises using the electrolytic cell at a temperature in the range of from about -70° C. to about 40° C. In some embodiments, the method step of using the electrolytic cell to produce H₂ and O₂ from the brine solution comprises using the electrolytic cell at a temperature in the range of from about -70° C. to about 25° C. In some embodiments, the method step of using the electrolytic cell to produce H₂ and O₂ from the brine solution comprises using the electrolytic cell at a temperature in the range of from about -70° C. to about 0° C. In some embodiments, the method step of using the electrolytic cell to produce H₂ and O₂ from the brine solution comprises using the electrolytic cell at a temperature in the range of from about -70° C. to about -5° C. In some embodiments, the method step of using the electrolytic cell to produce H₂ and O₂ from the brine solution comprises using the electrolytic cell at a temperature in the range of from about -70° C. to about -20° C. In some embodiments, the method step of using the electrolytic cell to produce H₂ and O₂ from the brine solution comprises using the electrolytic cell at a temperature less than about -5° C.

In some embodiments, the method step of using the electrolytic cell to produce H₂ and O₂ from the brine solution comprises using the electrolytic cell at a temperature in the range of from about -5° C. to about 40° C. In some embodiments, the method step of using the electrolytic cell to produce H₂ and O₂ from the brine solution comprises using the electrolytic cell at a temperature in the range of from about 0° C. to about 40° C. In some embodiments, the method step of using the electrolytic cell to produce H₂ and O₂ from the brine solution comprises using the electrolytic cell at a temperature in the range of from about -5° C. to about 25° C.

In some embodiments, the H₂ and O₂ are concurrently produced. In some embodiments, the H₂ and O₂ are concurrently produced and are essentially free of Cl₂. In some embodiments, the H₂ and O₂ being concurrently produced and being essentially free of Cl₂ means that Cl₂ is produced in an amount less than about 10%, less than about 5%, less than about 3%, less than about 1%, less than about 0.5% or less than about 0.1% of the total products. In some embodiments, the H₂ and O₂ are concurrently produced and are essentially free of CO. In some embodiments, the H₂ and O₂ being concurrently produced and being essentially free of CO means that CO is produced in an amount less than about 10%, less than about 5%, less than about 3%, less than about 1%, less than about 0.5% or less than about 0.1% of the total products.

In some embodiments, the perchlorate salt is added to the brine solution. In some embodiments, the brine solution comprises a perchlorate salt that is added to a natural brine solution. In some embodiments, the brine solution is a terrestrial brine solution. In some embodiments, the brine solution is a seawater brine solution.

In some embodiments, the brine solution naturally comprises a perchlorate salt. In some embodiments, the brine solution is an extraterrestrial liquid water brine solution. In some embodiments, the brine solution is a Martian liquid water brine solution.

In some embodiments, the brine solution is a mixture of a terrestrial brine solution and an extraterrestrial liquid water brine solution.

### EXAMPLES

### Materials and Methods

### Synthesis of Lead Ruthenate Pyrochlores (Pb₂Ru₂O_{7-δ})

5 mmol Ruthenium (III) nitrosylnitrate (Ru(NO)(NO₃)₃, Ru 31.3% minimum, Alfa Aesar) were dissolved in 25 mL of DI water (18.2 MΩ cm) and stirred for 10 minutes. 5 mmol lead (II) nitrate (Pb(NO₃)₂, 99.999%, Sigma Aldrich) was also separately dissolved in 25 mL DI water and stirred for 10 minutes. The solutions were mixed and stirred for an additional 30 minutes. Subsequently, the mixture was added to 500 mL 4 M KOH solution and a precipitate was obtained. The precipitate was crystallized by maintaining the KOH solution at 85° C. with continuous oxygen bubbling for 5 days. The solution volume was maintained by adding DI water every 24 hours. Following 5 days of crystallization, the solid was separated by centrifugation (Thermo Scientific, Heraeus Multifuge X1) at 10000 rpm, with a subsequent centrifugal wash with DI water until pH 7-8 was achieved. Upon reducing the pH, the solid was further washed 3 times with glacial acetic acid followed by acetone (3 times) and dried at 60° C. overnight in an oven. The dry solid was ground and used for experiments.

### Analytical Characterization of Lead Ruthenate Pyrochlores (Pb₂Ru₂O_{7-δ})

The electrical conductivity of Pb₂Ru2O_{7-δ} was measured using a custom two-electrode conductivity cell consisting of two Cu solid rods encased in a hollow polyether ether ketone (PEEK) block. The powdered samples were placed between the Cu rods and compressed at a constant torque of 0.29 kg-m to ensure good electrical contact. The resistance (Ω, ohm) was calculated using electrochemical impedance spectroscopy (EIS) with a frequency range of 0.1-10⁵ Hz with amplitude of 10 mV. The conductivity was measured according to the following formula:

$$σ = \frac{l}{R \times A} \qquad \text{(Eq. 1)}$$

where, σ is conductivity (S cm⁻¹), l is the sample thickness (cm), R is the measured resistance (ohm) and A is the cross-sectional area (cm²).

The morphology of the samples and their elemental composition was examined using scanning electron microscopy (SEM) coupled with energy dispersive analysis of X-rays (EDAX) using a JEOL JSM-7001 LVF Field Emission SEM. Crystallographic characterization using X-ray diffraction (XRD) was carried out with a Bruker d8 advance x-ray diffractometer, scanning from 20 to 80° (2θ) at a rate of 0.5° minute-¹ followed by Rietveld refinement to determine the lattice constant. X-ray photoelectron spectroscopy (XPS) was performed on Pb₂Ru₂O_{7-δ} using 5000 VersaProbe II Scanning ESCA Microprobe with A1 K-alpha x-ray source to determine the surface elemental composition and oxidation states. N₂ adsorption-desorption isotherms obtained using a QuantaChrome (QuantaSorb) instrument were analyzed using the Brunauer-Emmett-Teller (BET) model to determine the catalyst specific surface area.

### Experimental Simulation of Martian Environment

The Martian regolith composition has been determined to have substantial concentrations of perchlorate salts. This composition is shown below in Table 1.

TABLE 1

Martian regolith composition as determined from surface samples from the Phoenix lander.

| Ion | Measured concentration (moles x 10⁻⁵/cm³) |
|---|---|
| Na⁺ | 3.23 |
| K⁺ | 0.74 |
| Ca²⁺ | 1.28 |
| Mg²⁺ | 7.31 |
| Cl⁻ | 0.97 |
| ClO₄⁻ | 5.83 |
| SO₄²- | 13.4 |

All experiments were performed in a simulated Martian environment. The low Martian terrestrial temperatures (-36° C.) were maintained by immersing the entire electrochemical experimental setup in a dry-ice bath with an ethylene glycol and ethanol mixture. By controlling the ratio of ethanol and ethylene glycol the temperature was lowered to -36° C. The CO₂-rich Martian atmosphere was simulated by purging CO₂ into the electrolyte. All measurements were carried out in a 2.8 M Mg(ClO₄)₂ solution to mimic the anticipated liquid brine solutions on the Martian surface. Despite the low atmosphere pressure in Mars, the regolithic brines remained in the liquid phase.

### Electrochemical Measurements of Lead Ruthenate Pyrochlores (Pb₂Ru₂O₇₋δ)

The ORR and OER electrochemical activities of Pb₂Ru₂O_{7-δ} at various reaction regimes were evaluated using the standard rotating disk electrode (RDE) method. Catalyst inks were prepared by ultrasonication (QSonica; Q700 sonicator) of a mixture of 25 mg catalyst, 6 mL of 24% (vol/vol) isopropanol/water, 0.275 mL of Nafion solution (Sigma Aldrich; 5 wt % solution in aliphatic alcohols) and 0.250 mL of 1 M KOH for 10 minutes (1 minute of sonication followed by 30 seconds cool down). KOH was added to neutralize the acidity of Nafion to preclude the possibility of Pb₂Ru₂O_{7-δ} exposure to acidic environments.

Electrochemical measurements were carried out using a conventional three-electrode setup (Pine instruments, AKCELL). The working electrode (WE) consisted of a thin-film of 200 µg cm⁻²_{disk} of Pb₂Ru₂O_{7-δ} supported on glassy carbon (GC). The WE was prepared by drop casting 10 µL of the Pb₂Ru₂O₇-_{δ} ink onto a 0.196 cm² GC electrode polished to a mirror-like finish using 0.05 µm alumina slurry (Pine Instruments). The ink was dried in an uniform manner with homogenous particle distribution by rotating the RDE rotor at 400 rpm in an inverted position. Pt mesh and Ag wire were used as the counter and pseudo-reference electrode respectively. Linear sweep voltammetry (LSV) was recorded by sweeping the potential at 20 mV s⁻¹ in N₂-, O₂- and CO₂-saturated 2.8 M Mg(ClO₄)₂ electrolyte at different temperatures. The non-faradaic, capacitive current contributions were obtained from the scans under a N₂ atmosphere.

Solution resistance was measured as 10 Ω using EIS. Cathodic and anodic potential scans were carried out to measure the ORR and OER currents. All the LSV scans were corrected for resistive and capacitive contributions. The measurements were carried out at different temperatures between 21° C. to -36° C. The OER measurements were carried out under both O₂ and CO₂ atmospheres while ORR was carried out only with O₂-saturated electrolyte.

### Simulated Martian Regolithic Brine Electrolyzer

The Pb₂Ru₂O_{7-δ} OER electrocatalyst was integrated into a 5 cm² single cell (Fuel Cell Technologies Inc.) solid-state alkaline water electrolyzer fed with CO₂ purged 2.8 M Mg(ClO₄)₂ operated at average Earth (21° C.) and Martian terrestrial temperatures (-36° C.). The anode bipolar plate was a corrosion-resistant titanium metal plate (2 × 2 mm² single parallel flow channels) to avoid carbon corrosion whereas cathode was a graphite plate (1 × 1 mm² three serpentine flow channels). A membrane electrode assembly (MEA) was fabricated by sandwiching an anion exchange membrane (AEM, Fumasep FAA-3-50, thickness = 50 µm) between two gas diffusion electrodes (GDE). GDEs were prepared by painting catalyst ink with a N₂-propelled airbrush (Badger 150) on gas diffusion layers (GDLs) consisting of carbon paper with high wettability on the cathode side and titanium sheet on the anode side to avoid corrosion. For the anode, the Pb₂Ru₂O_{7-δ} ink was prepared by sonicating 0.05 g catalyst, 3.2 g isopropanol/water (1/1 vol%) and 0.176 g of 5 wt% solubilized AEM binder (Fumion FAA-3, Fumatech). For the cathode, the Pt/C catalyst (Pt 46.5%, Tanaka, Japan) ink was prepared by sonicating 0.05 g catalyst, 3.2 g isopropanol/water (1/1 vol%) and 0.428 g of 5 wt% solubilized AEM binder. This composition yields a catalyst to binder ratio of 85:15 and 70:30 for the anode and cathode, respectively. The Pb₂Ru₂O_{7-δ} loading was 1 mg cm⁻² on the anode side whereas Pt/C loading was maintained as 0.5 mg_{Pt} cm⁻² on the cathode side. The MEAs were ion-exchanged to the OH⁻ form by immersing the AEM and electrodes in three batches of 1 M KOH each for 8-10 hours for a total of 24-30 hours followed by a thorough DI water wash. After the electrolyzer was assembled, 2.8 M Mg(ClO₄)₂ purged with CO₂ was fed to the electrolyzer at room temperature and Martian temperature (-36° C.) with a flow rate of 200 mL min⁻¹. A potential stair-step protocol was applied with the anodic sweep from 1.2 V to 2.2 V and the data was recorded following current relaxation after a 1 minute potentiostatic hold.

### Results and Discussion

### OER Activities

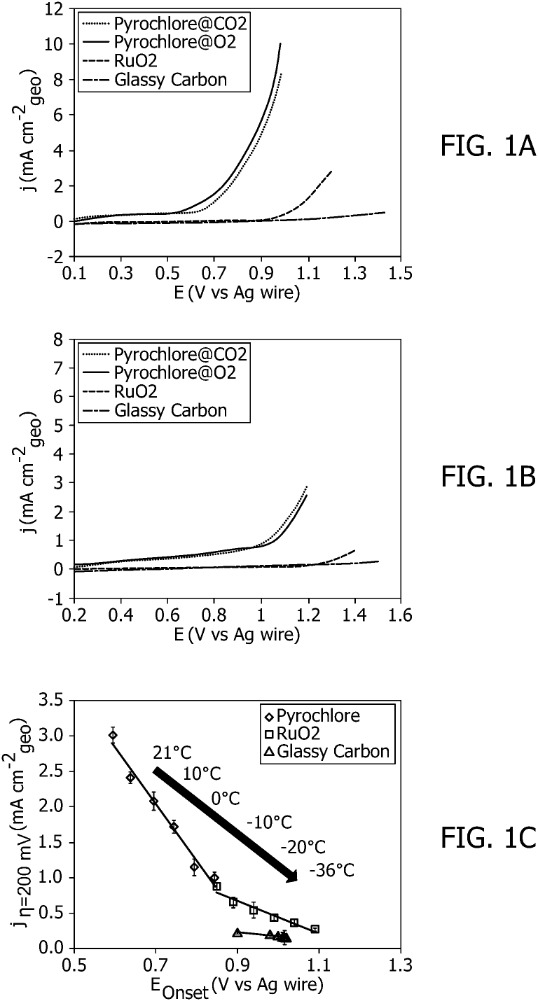

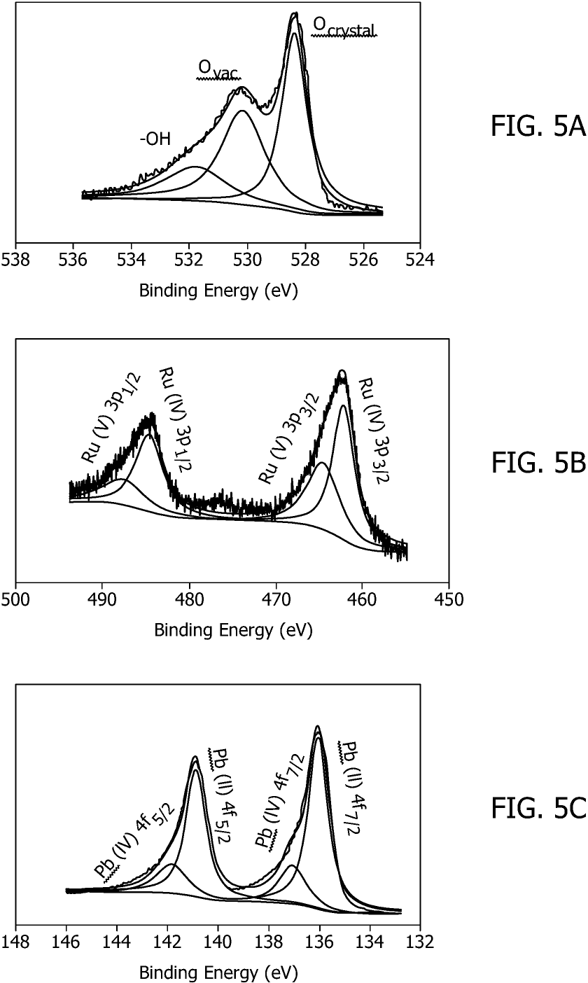

The OER activity of a synthesized Pb₂Ru₂O_{7-δ} pyrochlore electrocatalyst was examined in the SMRB and contrasted with a RuO₂ benchmark electrocatalyst. Linear sweep voltammograms (LSVs) that were obtained using a thin film rotating disk electrode (RDE) for different catalysts at 21° C. and -36° C. are depicted in FIGS. 1A and 1B, respectively. Initial measurements carried out in O₂-saturated SMRB showed minimal faradaic contributions from the base, glassy carbon (GC) electrode with a small increase in the current at potentials over 1.3 V vs. Ag wire. RuO₂ exhibited OER activity at potentials over 0.9 V vs. Ag wire whereas Pb₂Ru₂O_{7-δ} was OER-active even at 0.1 V vs. Ag wire. The results confirmed significantly more facile OER kinetics of Pb₂Ru₂O_{7-δ} when compared to RuO₂ and GC in SMRB. The improved OER activity on Pb₂Ru₂O_{7-δ} is a function of the surface oxygen vacancies on this electrocatalyst. XPS data for this electrocatalyst are shown in FIGS. 5A-5C.

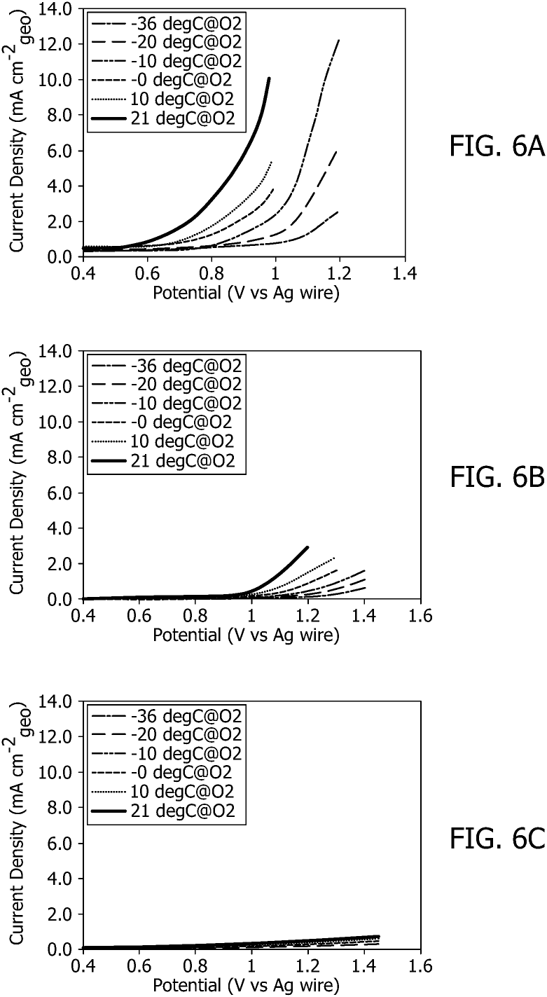

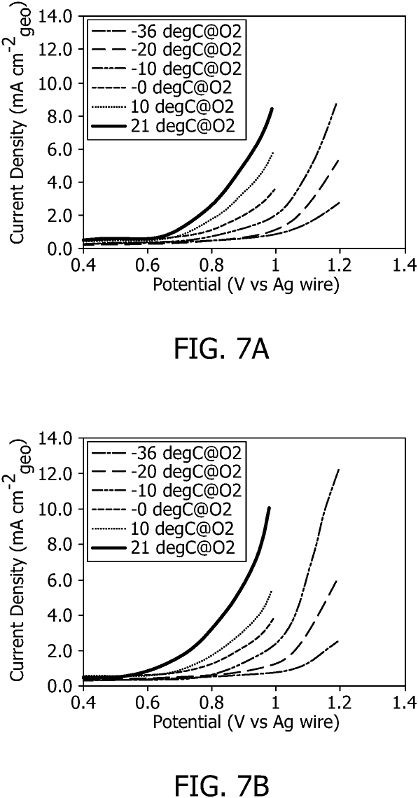

The OER activities for all the electrodes were also compared upon application of a constant overpotential (200 mV) as depicted in FIG. 1C and the relative activity trends were seen to hold across a wide range of temperature from 21° C. to -36° C. (the corresponding LSVs are depicted in FIGS. 6A-6C and FIGS. 7A-7B). Having established the superior OER activity of Pb₂Ru₂O_{7-δ} in an O₂-staurated SMRB, the OER activity was examined in a CO₂-saturated SMRB more representative of conditions on Mars. The activity and the overpotential were largely unaffected by the shift from O₂ to CO₂ saturated SMRB (within experimental error) as seen in FIGS. 1A and 1B.

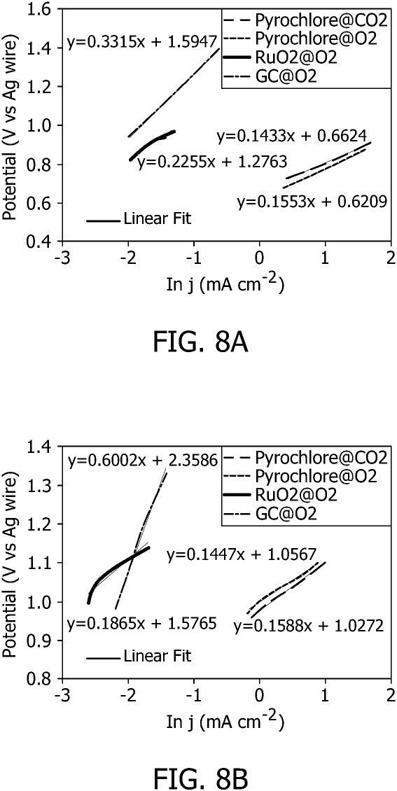

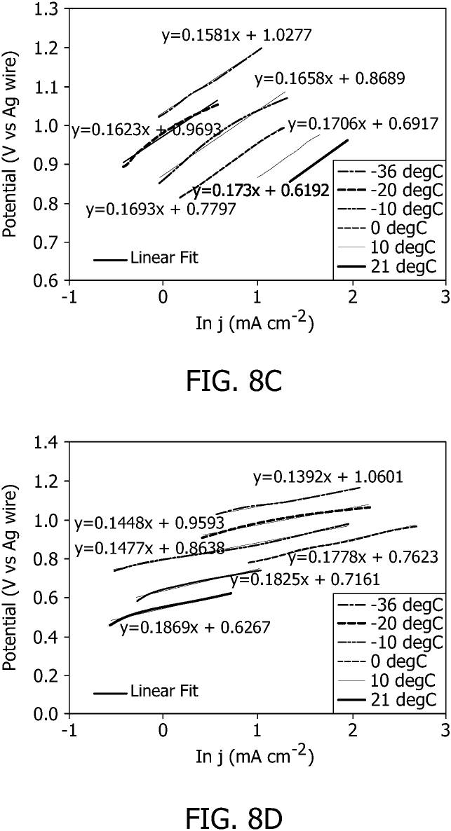

Pb₂Ru₂O_{7-δ} was also tested across a range of temperatures in CO₂-saturated SMRB (FIGS. 7A-7B), exhibiting a similar trend as that seen in O₂-staurated SMRB. Pb₂Ru₂O_{7-δ} was found to exhibit greater bifunctional ORR (oxygen reduction reaction)/OER activity as compared to RuO₂ in near-neutral media by applying the Marcus-Hush kinetic formulation to the Tafel analysis of the LSVs. Tafel slopes are shown in FIGS. 8A-8D. This provides a pathway for the utilization of the H₂ produced by the electrolyzer in a fuel cell with a Pb₂Ru₂O_{7-δ} cathode and for the eventual development of a unitized regenerative fuel cell (URFC) for use in Mars-like conditions.

### Reaction Conditions

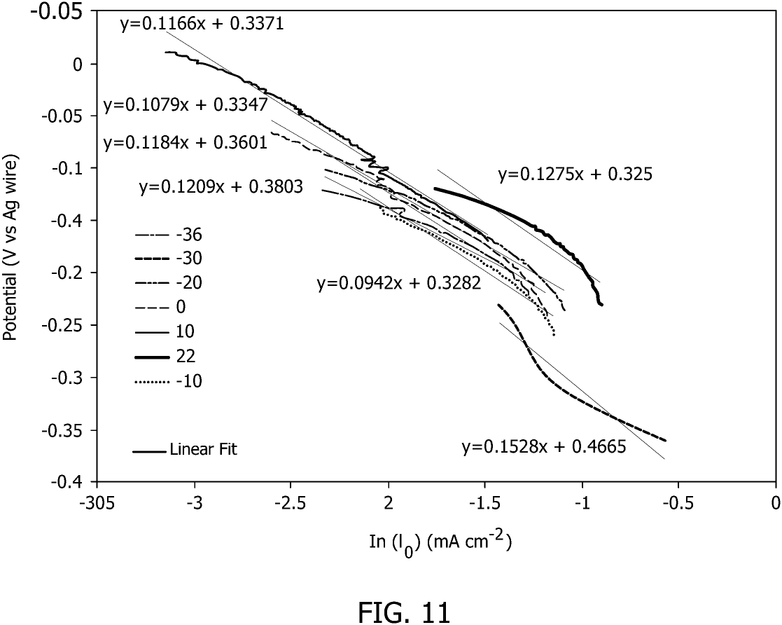

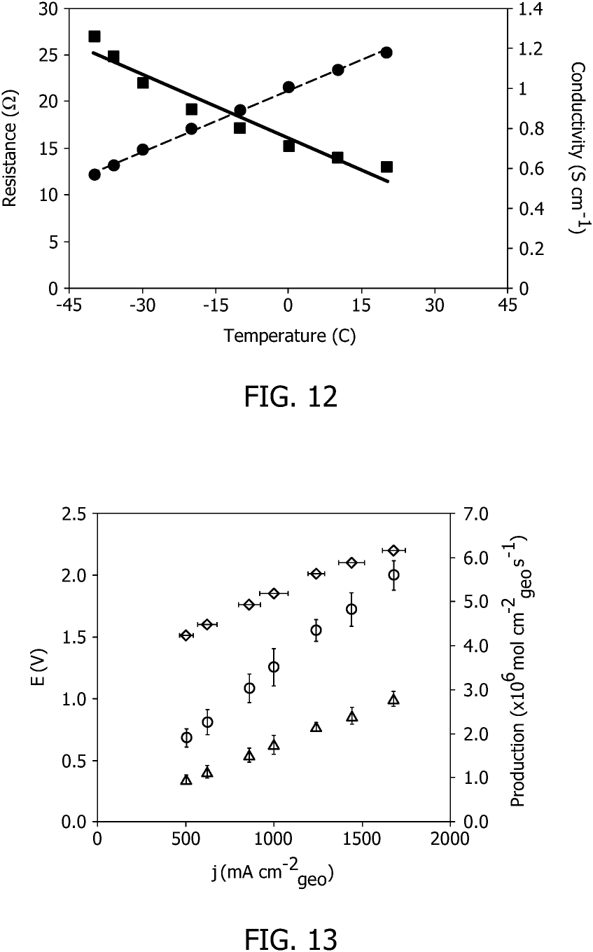

To identify the limiting reaction in the SMRB electrolyzer, the hydrogen evolution reaction (HER) was examined on Pt/C in CO₂-saturated SMRB over a range of temperatures from 21° C. and -36° C. (FIG. 11). Given that the ratio of overpotential to current density (i.e. the Tafel slope) is lower for the ORR (94-152 mV/dec) at all the temperatures compared to the OER (158-173 mV/dec) on Pb₂Ru₂O_{7-δ} under the same conditions (FIG. 8C), it is apparent that the oxygen electrode is the limiting electrode. The ionic conductivity of the electrolyte was also found to exhibit a linear relationship (decrease) with temperature over the entire range from 21° C. to -36° C. (FIG. 12). The effect of change in solution conductivity on OER and ORR activity was considered during the calculation (iR drop correction).

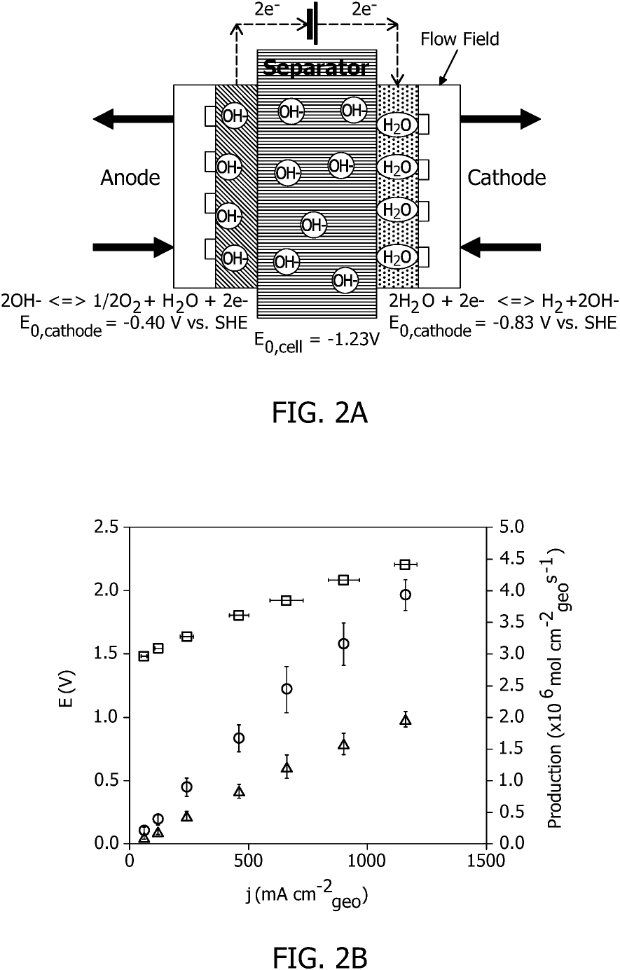

Electrolyzers built with Pb₂Ru₂O_{7-δ} anodes, a commercial Fumasep FAA-3-50 anion-exchange membrane (AEM) separators, and Pt/C cathodes (FIG. 2A) were operated with a 200 mL min⁻¹ CO₂ saturated SMRB feed to both the anode and cathode to mitigate water transport/membrane drying issues. Anticipated CO₂ poisoning of the AEMs was mitigated by regenerating the AEM using potentiostatic holds at higher potentials. Following an initial 30-minute potentiostatic hold at 2.5 V, the electrolyzer was polarized in steps between 1.4 V - 2.2 V and allowed to relax to a steady electrolyzing current. The resultant polarization (j-E) performance was recorded and the corresponding O₂ and H₂ production rates are shown (j-E curve at 21° C. in FIG. 13 and -36° C. in FIG. 2B). For the test in simulated Martian conditions, the feed was constantly purged with CO₂ and the electrolyzer temperature was maintained at -36° C. by employing a carefully calibrated bath of dry-ice with an ethylene glycol and ethanol mixture.

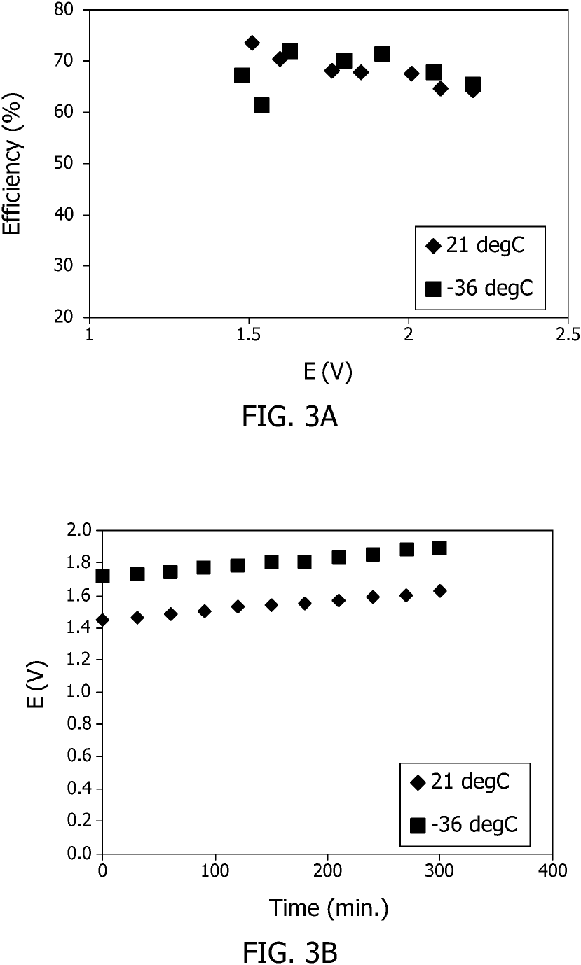

At both temperatures, the electrolyzer showed excellent performance with peak power densities of 1.23 W.cm⁻² (1.92 V, -36° C.) and 1.85 W.cm⁻² (1.85 V, 21° C.), with the decrease in performance in direct correlation to the device temperature being attributed to a combination of lower faradaic currents due to lower reaction rates and increased device resistance due to sluggish ion transport. To put the performance in perspective, reported solid-state alkaline water electrolyzers operating at 50° C. with a Pb₂Ru₂O_{7-δ} anode achieved a power density of 1.2 W.cm⁻² at 1.85 V using a DI water feed. The electrolyzer was found to exhibit a faradaic efficiency of about 70% (FIG. 3A) and was found to experience about a 200 mV increase in voltage during a 300-minute constant current hold at 400 mA cm⁻² (FIG. 3B). Previous investigations have attributed similar increases in the electrolyzer resistance to the possible degradation of the commercial AEM binder at the anode. Given the operating conditions on Mars, judicious material selection is of paramount importance for future operational deployment.

### Comparison to MOXIE

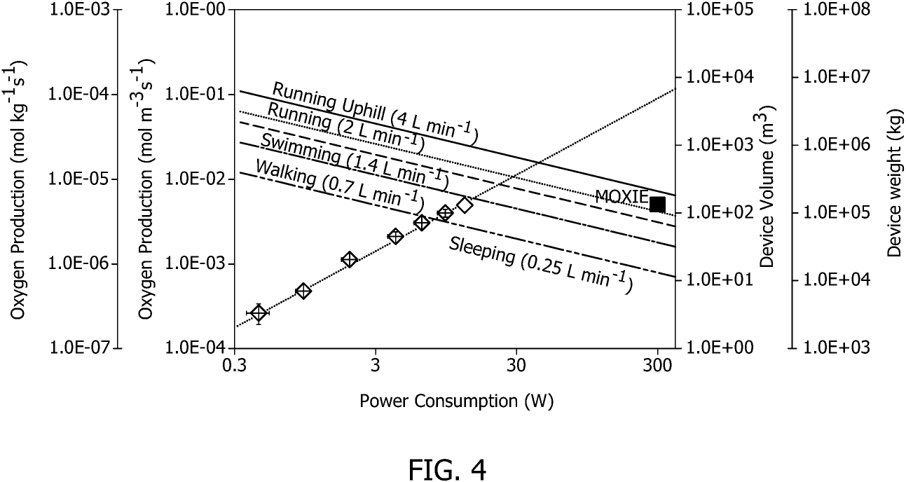

The metrics of the SMRB electrolyzer described herein were compared to existing plans for the generation of O₂ on Mars. MOXIE, developed by MIT and NASA as a test bed on the Mars 2020 mission, has been designed to produce 10-22 g. hr⁻¹ of O₂ by the electrolysis of CO₂. Utilizing the abundant CO₂ present in the Martian atmosphere, MOXIE produces O₂ and CO, with pure O₂ obtained by subsequent purification. Despite utilizing an abundant and geographically unconstrained feedstock, the production of CO represents a toxic inhalation hazard. Due to the differing design philosophies, the performances of electrolyzers in accordance with the present disclosure have been compared with MOXIE purely on the basis of the rate of O₂ production (FIG. 4). Further, the device weight and volume requirements to achieve a given O₂ production rate at rated operating power consumption have been examined FIG. 4). The values of O₂ consumption for various human activities at sea level on Earth was obtained from the US Navy Dive manual. To match MOXIE’s O₂ production rate (10-22 g. hr⁻¹), an electrolyzer in accordance with the present disclosure needs to operate at a cell potential of 2.2 V with an electrode area of 28 - 62 cm². A healthy human being requires around 90 Lo₂.hr⁻¹ and 300 L_{O2}.hr⁻¹ while resting and exercising heavily, respectively. Operating the present electrolyzer at 2.2 V, the cell active area required to satisfy these requirements is 375 cm² and 1235 cm², respectively. The present system produces more than 25 times the O₂ as MOXIE while consuming the same amount of power (FIG. 4). Extrapolating to the required production rates for various human activities, this electrolyzer will be smaller in both weight and volume compared to the current state-of-the-art MOXIE O₂-generator (FIG. 4). Based on these results, electrolyzers in accordance with the present disclosure will enable concurrent fuel and oxygen production at viable rates from Martian regolithic brines.

### Analysis

### Analytical Characterization

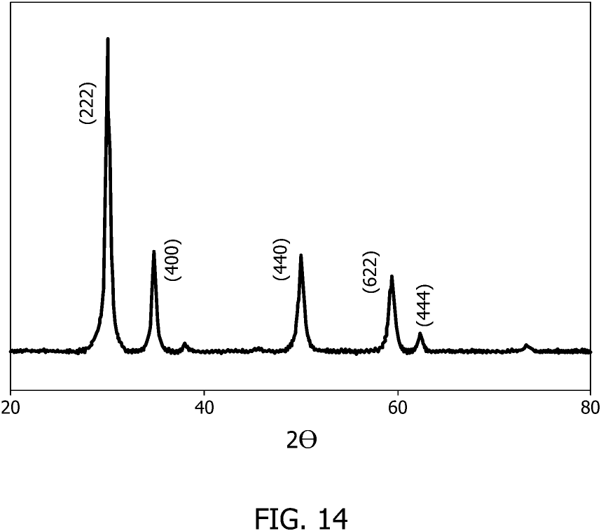

XRD on freshly prepared samples confirmed the presence of Pb-Ru pyrochlore phases (FIG. 14) when compared to the characteristic peaks of Pb₂Ru₂O_{7-δ} phases (JCPDS-ICDD = PDF-00-002-1365). The absence of additional peaks indicated the presence of high purity pyrochlore phases without any mixed oxide phases. Rietveld refinement yielded lattice constants of a=b=c=10.325 Å in agreement with prior reports. The manifestly high crystallinity of the sample, attributable to extensive O₂-purging (5 days) at 85° C. obviated the need for further annealing.

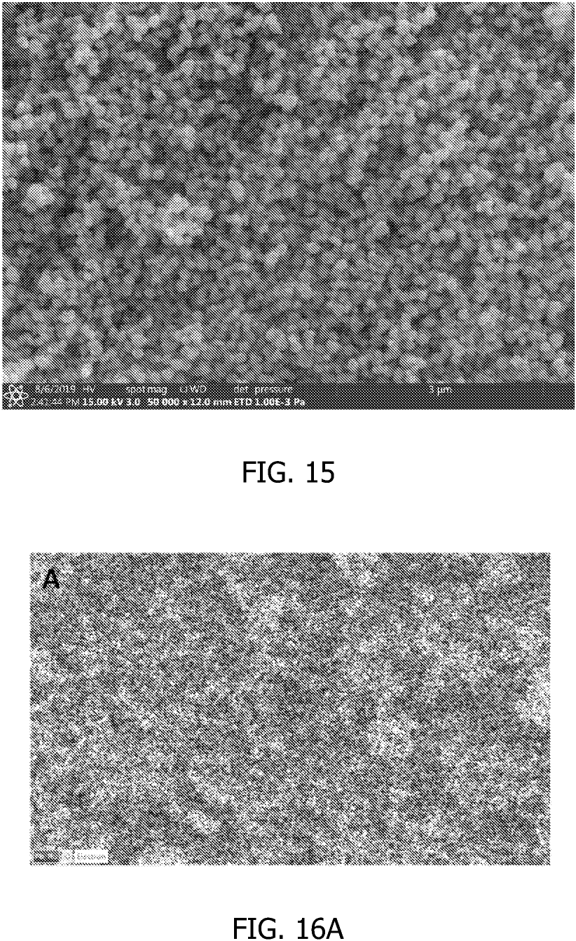

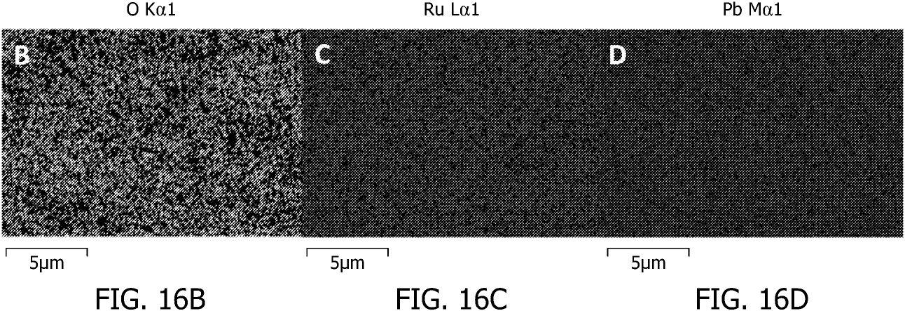

FIG. 15 depicts SEM micrographs indicating the formation of 70-140 nm spherical Pb₂Ru₂O_{7-δ} particles. The formation of Pb-Ru-O system and the composition were confirmed by EDAX mapping (FIGS. 16A-16D). XPS of the samples detected the presence of multiple oxidation states of Pb, Ru, and O in Pb₂Ru₂O_{7-δ}. The deconvolution of O 1 s spectrum yielded three distinct peaks at about 528.3 ± 0.2 eV, about 530 ± 0.1 eV, and about 531 ± 0.5 eV corresponding to O-atoms in crystal lattice, auxiliary oxidation state of O-atom due to creation of oxygen vacancy and surface —OH state of O-atoms, respectively (FIG. 5A). The deconvoluted Ru 3p XPS spectrum showed the presence of two different oxidation states of Ru: Ru (IV) 3p_{3/2}, Ru (V) 3p_{3/2}, Ru (IV) 3p_{½} and Ru (V) 3p_{½} at about 462.5 ± 0.4 eV, about 464.5 ± 0.4 eV, about 484.3 ± 0.2 eV and about 486.6 ± 0.3 eV, respectively (FIG. 5B). Deconvolution of Pb 4f XPS peak shows the presence of Pb (II) 4f_{7/2}, Pb (IV) 4f_{7/2}, Pb (II) 4f_{5/2} and Pb (IV) 4f_{5/2} at 136.2 ± 0.2 eV, 137.3 ± 0.3 eV, 141.3 ± 0.1 eV and 142.2 ± 0.2 eV, respectively (FIG. 5C). BET surface area of the Pb₂Ru₂O_{7-δ} sample has been found to be 90 ± 4 m²/g. The conductivity of Pb₂Ru₂O_{7-δ} sample has been calculated as 82 ± 4 S/cm.

### The Thermodynamics of Martian Regolithic Brines

The low Martian atmospheric pressure, of about 6.4 mbar depresses the boiling point of pure water to -39.9° C. This effect is countered in highly concentrated Mg(ClO₄)₂ brines where the high salt concentration elevates the boiling point. The boiling-point elevation is calculated via the following equation:

$$Δ {T}_{b} = {K}_{b} {b}_{B} \qquad \text{(Eq. 2)}$$

where, ΔT_{b} is the elevation in boiling-point (T_{b}(ₛₒₗᵤₜᵢₒₙ) - T_{b}(ₚᵤᵣₑ solvent)), K_{b} is the ebullioscopic constant of pure solvent (0.512 for pure water), and b_{B} is molality of the solution. b_{B} is calculated as b_{B} = bₛₒₗᵤₜₑi. Where, bₛₒₗᵤₜₑ is the molarity of the solute and i is the van’t Hoff factor which is about 3 for Mg(ClO₄)₂. Equation 2 predicts a ΔT_{b} of 4.3° C. for 2.8 M Mg(ClO₄)₂, resulting in a boiling point of -35.6° C. Therefore, the perchlorate brine will neither freeze via freezing point depression nor vaporize/boil (vapor pressure_{water@-40}_{degC} = 0.39 mbar << 6.38 mbar = Martian atmospheric pressure) via boiling point elevation, allowing for the presence of liquid water solutions on the Martian surface.

The simulation of terrestrial Martian temperature accounted for the large diurnal temperature range, low atmospheric pressure, and highly concentrated perchlorate brine. The low diurnal temperatures (-39° C. to -81° C.) suggested that water is most likely to be present in the solid/ice state. However, water present in highly concentrated perchlorate brines experiences a freezing point depression resulted in a freezing temperature below -60° C. Therefore, spatiotemporal conditions exist on Mars to allow for the presence of liquid brine solutions. The extreme hygroscopic nature of perchlorate salts will also result in the absorption of atmospheric moisture even when present in very low concentrations of up to 210 ppm.

### Electrochemistry in Simulated Martian Environment

The OER activity of Pb₂Ru₂O_{7-δ} in O₂-purged simulated Martian regolithic brine (SMRB) was measured over a range of temperatures (21° C. to -36° C.) and benchmarked against RuO₂ and GC. Pb₂Ru₂O_{7-δ} exhibited higher OER currents (and hence OER activity) over the entire OER potential window compared to RuO₂ and GC at any temperature (FIGS. 6A-6C). FIGS. 7A-7B depict the impact of the purged gases on the OER activity of Pb₂Ru₂O₇-δ. The OER activity was unchanged between O₂ and CO₂ purged environment but the CO₂ purged SMRB exhibited <100 mV increase in the onset potential confirming minimal effect of gas environment. E vs. log j (Tafel) plots exhibited lower slopes for Pb₂Ru₂O_{7-δ} (144 - 155 mV dec⁻¹), demonstrating lower overpotentials/facile kinetics for OER compared to RuO₂ (187 - 225 mVdec⁻¹) and GC (331 - 600 mVdec⁻¹) electrodes at 21 and -36° C. (FIGS. 8A and 8B). Tafel slopes (given by

$$\left(b = - \frac{2.3 R T}{a F}\right)$$

close to 118 mV dec⁻¹ indicate that the first electron transfer step is rate determining which confirms oxygen vacancy sensitive OER and the transfer coefficient (α) is 0.5, rendering both the forward and backward reaction equally facile. The effect of the solvation shell on charge transfer at (or near) electrode surfaces has previously been demonstrated.

The increasing Tafel slopes as a function of the temperature indicate an asymmetry in the overpotentials needed for the OER and ORR as the ORR is solvation controlled whereas OER is solvation independent as the solvent itself is the reactant (FIGS. 8C and 8D). The Tafel slopes depicted in FIGS. 8A-8D are seen to be independent of the purge gas while the intercept varies in line with the onset potential from the LSVs. Temperature was found to have no influence on the mechanism as the Tafel slopes were unchanged with temperature. The expected drop in the reaction rate constant was evident in the decrease in the intercept and hence the exchange current density. The low Tafel slopes exhibited by Pb₂Ru₂O_{7-δ} indicate that α is closer to 0.5 and hence the energetics of the ORR and OER are facile, in line with the observations of bifunctional ORR/OER activity. The higher concentration of surface oxygen vacancies as well as higher oxidation states of surface Ru (Ru(IV) and Ru(V)) as confirmed by XPS (FIGS. 5A-5C) on Pb₂Ru₂O_{7-δ} as compared to RuO₂ (Ru(IV)) facilitate higher adsorption of water (S + H₂O ➔ S-OH + H⁺ + e⁻) to promote the first electron transfer, improving the OER activity analogous to Co₃O₄ electrocatalysts reported in the literature.

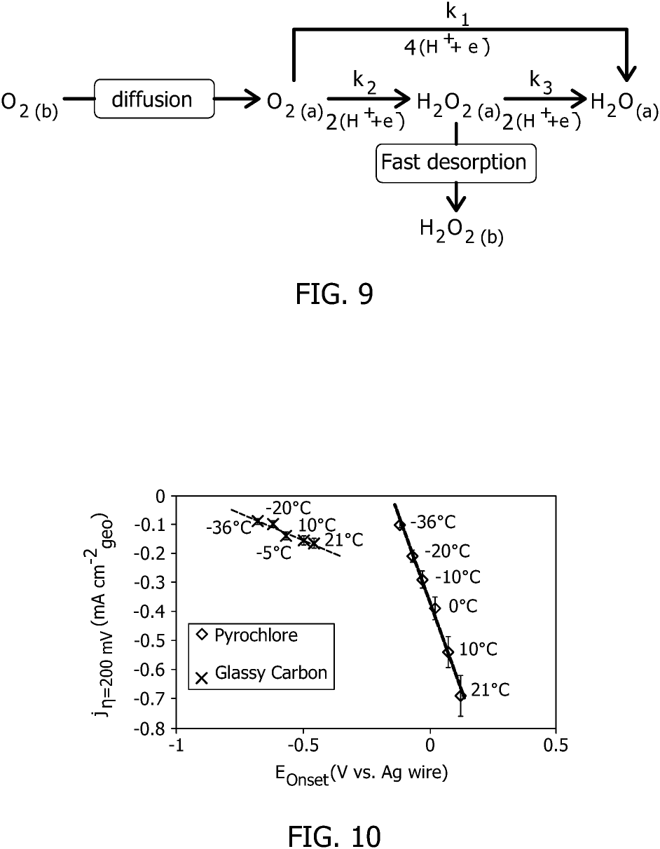

FIG. 9 depicts possible, non-limiting pathways for the reduction of O₂ in an acidic or near-neutral aqueous environment. The initial step in the ORR mechanism was considered to be the adsorption and subsequent reduction of oxygen to the superoxide radical. Outer sphere electron transfer to form O₂⁻ and the possible subsequent adsorption of the superoxide radical was also considered. The further electrochemical reduction of adsorbed O₂ (or O₂⁻) by protons is dependent on the adsorption orientation of the oxygen species with end-on, side-on, and bridge type adsorption being possibilities dictated by the nature of the electrode. Side-on adsorption is possible when the spacing between the catalytic active sites and the bond length of O₂ (or O₂⁻) are similar. Discussion regarding surface O₂ vacancies and the orientation renders an electrophilic H⁺ attack on either O atom equally likely and offers the best possibility to follow a direct 4-electron pathway to produce H₂O.

Alternatively, in end-on adsorption, the initial step is likely to be the formation of OOH species, followed by O—O bond cleavage and subsequent H⁺ attack to produce 20H* which further reacts to produce 2H₂O.

Alternatively, the formation of OOH maybe followed by the addition of another H⁺ to produce H₂O₂. The H₂O₂ further reacts with a series of H⁺ ions to produce 20H and then 2H₂O. The chemical decomposition of H₂O₂ to O₂ and the possible equilibriums in each of the steps in the mechanism are not considered due to the expected low concentration of H₂O₂ at the surface (due to constant convection during the rotation of the RDE) and the overpotential driving the reactions forward.

The ORR in the SMRB was examined at a range of temperatures to establish the activity of the Pb₂Ru₂O_{7-δ} electrocatalysts and then translate it to the simulated Martian conditions to produce energy on Mars in future. Given the wide range of temperatures examined and the consequent increase in the overpotential required to initiate ORR, the activity of the catalysts was examined at 200 mV overpotential at all temperatures, with the overpotential chosen to improve the faradaic efficiency of the overall unitized regenerative fuel cell (URFC = electrolyzer and fuel cell) system. In FIG. 10, the superior activity of Pb₂Ru₂O_{7-δ} compared to GC electrode is apparent at 21° C., with a 500 mV lower ORR onset potential and about three times the activity which is again attributed to high O₂ adsorption, subsequent dissociation facilitated by high oxygen vacancy content. Given that GC is poor catalyst for the 4-electron ORR to produce H₂O, it exhibits minimal activity loss when the system is cooled from 21° C. to -36° C. On the other hand, Pb₂Ru₂O_{7-δ} exhibit significant (~⅓ times) activity loss over the same temperature range. However, despite the activity loss, the pyrochlore electrocatalyst still exhibits an onset potential that is about 500 mV lower than GC in a simulated Martian environment, providing a pathway to potential URFC development for energy and fuel production.

This written description uses examples to illustrate the present disclosure, including the best mode, and also to enable any person skilled in the art to practice the disclosure, including making and using any compositions or systems and performing any incorporated methods. The patentable scope of the disclosure is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed disclosure. The term “consisting essentially of” occupies a middle ground between “comprising” and “consisting of”.

Where a disclosure or a portion thereof is defined with an open-ended term such as “comprising,” it should be readily understood that (unless otherwise stated) the description should be interpreted to also describe such a disclosure using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the disclosure are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

What is claimed is:

1. An electrolytic cell comprising:
a cathode;
an anode comprising a pyrochlore;
an ion exchange membrane separating the cathode and the anode; and
a brine solution in contact with the anode and the cathode, wherein the brine solution optionally comprises a perchlorate salt.

2. The electrolytic cell of claim 1, wherein the brine solution comprises NaCl in a concentration in a range of from about 0.05% to about 3%.

3. The electrolytic cell of claim 1, wherein the brine solution comprises NaCl in a concentration in a range of from about 3% to about 5%.

4. The electrolytic cell of claim 1, wherein the brine solution comprises NaCl in a concentration in a range of from about 5% to about 28%.

5. The electrolytic cell of claim 1, wherein the brine solution does not comprise a perchlorate salt.

6. The electrolytic cell of claim 1, wherein the brine solution comprises a perchlorate salt selected from the group consisting of Mg(C1O₄)₂, Ca(C1O₄)₂, NaC1O₄, salts of Li, Ba, K, and Mg, and combinations thereof.

7. The electrolytic cell of claim 1, wherein the brine solution comprises a perchlorate salt in a concentration in the range of from about 0.1 M to about 3 M.

8. The electrolytic cell of claim 1, wherein the pyrochlore is a compound according to Formula I: 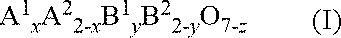
wherein
A¹ and A² are each independently selected from the group consisting of Pb, Y, La, Gd, Bi, Dy, Cd, T1, and Ca;
B¹ and B² are each independently selected from the group consisting of Ru, Ir, Rh, Re, Sn, Ti, Pt, Os, Zr, and Pd;
x is a value between 0 and 2;
y is a value between 0 and 2; and
z is a value between 0 and 1.

9. The electrolytic cell of claim 1, wherein the pyrochlore is essentially free of Bi.

10. The electrolytic cell of claim 1, wherein the cathode comprises a catalyst selected from the group consisting of Pt, Pd, alloys of Pt and alloys of Pd supported on C, RuO₂, Ni(OH)₂, TiO₂, SnO₂, TiO₂ with Nb or Ru dopants, SnO₂ with Sb or Ta dopants, and combinations thereof.

11. The electrolytic cell of claim 1, wherein the ion exchange membrane is selected from the group consisting of an anion exchange membrane and a proton exchange membrane.

12. A method of using an electrolytic cell, the method comprising:
using the electrolytic cell to produce H₂ and O₂ from a brine solution;
wherein the electrolytic cell comprises:
a cathode;
an anode comprising a pyrochlore;
an ion exchange membrane separating the cathode and the anode; and
a brine solution in contact with the anode and the cathode, wherein
the brine solution optionally comprises a perchlorate salt.

13. The method of claim 12, wherein the method step of using the electrolytic cell to produce H₂ and O₂ from the brine solution comprises applying a current having a current density in the range of from about 500 mA/cm² to about 1500 mA/cm².

14. The method of claim 12, wherein the method step of using the electrolytic cell to produce H₂ and O₂ from the brine solution comprises using the electrolytic cell at a temperature in the range of from about -70° C. to about 40° C.

15. The method of claim 12, wherein the H₂ and O₂ are concurrently produced.

16. The method of claim 12, wherein the brine solution does not comprise a perchlorate salt.

17. The electrolytic cell of claim 12, wherein the brine solution comprises NaCl.

18. The method of claim 12, wherein the brine solution comprises a perchlorate salt that is added to a natural brine solution.

19. The method of claim 12, wherein the brine solution naturally comprises a perchlorate salt.

20. The method of claim 12, wherein the pH of the brine solution is in the range of from about 7 to about 8.
